(19) United States
(12) Patent Application Publication
(10) Pub. No.: US 2012/0274391 A1
(43) Pub. Date: Nov. 1, 2012

(54) FUSE CIRCUIT FOR SEMICONDUCTOR DEVICE

(76) Inventor: Jong-Su Kim, Gyeonggi-do (KR)

(21) Appl. No.: 13/331,594

(22) Filed: Dec. 20, 2011

(30) Foreign Application Priority Data
Apr. 28, 2011 (KR) 10-2011-0040351

(51) Int. Cl. H01H 85/00

(52) U.S. Cl. 327/525

(57) ABSTRACT

A fuse circuit of a semiconductor device includes a transfer unit configured to selectively transfer a corresponding address signal in response to a first test mode signal, a fuse control unit configured to drive an output end with a first voltage in response to an output signal of the transfer unit, a fuse unit including a MOS transistor having a gate coupled to the output end, and a fuse enable unit configured to selectively supply a second voltage to a source/drain of the MOS transistor of the fuse unit in response to the first test mode signal, wherein the fuse circuit is programmed by causing a breakdown of the MOS transistor in response to a voltage difference between the first voltage and the second voltage that are applied to the gate and the source/drain of the MOS transistor of the fuse unit.

### CROSS-REFERENCE TO RELATED APPLICATIONS

The present application claims priority of Korean Patent Application No. 10-2011-0040351, filed on Apr. 28, 2011, which is incorporated herein by reference in its entirety.

### BACKGROUND

1. Field

Exemplary embodiments of the present invention relate to a semiconductor integrated circuit designing technology, and more particularly, to a fuse circuit of a semiconductor device.

2. Description of the Related Art

A semiconductor integrated circuit includes circuits of the same pattern so that although a circuit has a defect due to a variable in fabrication process, a redundancy circuit may replace the defective circuit and thus the semiconductor integrated circuit may be still provided as a fine product.

Particularly, a semiconductor memory device includes numerous memory cells integrated in one chip. As semiconductor memory device are being integrated higher and higher, more numbers of memory cells are being integrated in one chip of a limited size. If when any one memory cell has a defect, the whole memory chip including the defective memory cell is discarded as a flawed product, the number of memory chips to be thrown away will increase enormously, thereby reducing the yield of semiconductor memory devices.

To address such features, a semiconductor memory device generally includes a fuse circuit and a redundancy cell array. The fuse circuit also includes a plurality of fuses having a type of metal line and the fuse circuit replaces a defective cell with a redundancy cell depending on whether a fuse blowing operation is performed or not during a repair process. The redundancy cell array and the fuse circuit are formed during a semiconductor device fabrication process. A memory cell that is determined as a defective cell is substituted with a redundancy cell in the repair process. The repair process is performed in such a manner that a fuse formed of a metal line is selectively cut off usually by using a laser beam.

The conventional fuse circuit, however, occupies a great circuit area because fuses are to be disposed with adequate margins from each other in consideration of the size of the laser beam in order to protect the other fuse circuits adjacent to a target fuse from being physically damaged when the target fuse is selectively blown by using the laser beam.

Also, since it is difficult to perform a laser blowing operation after packaging, there may be a limitation in coping with a margin test or malfunction of a semiconductor device after packaging.

### SUMMARY

An Exemplary embodiment of the present invention is directed to a fuse circuit of a semiconductor device that occupies a minimal circuit area and may be programmed using a test mode after packaging.

In accordance with an exemplary embodiment of the present invention, a fuse circuit of a semiconductor device includes a transfer unit configured to selectively transfer a corresponding address signal in response to a test mode signal, a fuse control unit configured to drive an output end with a first voltage in response to an output signal of the transfer unit, a fuse unit including a MOS transistor having a gate coupled to the output end, and a fuse enable unit configured to selectively supply a second voltage to a source/drain of the MOS transistor of the fuse unit in response to the test mode signal, wherein the fuse circuit is programmed by causing a breakdown of the MOS transistor in response to a voltage difference between the first voltage and the second voltage.

In accordance with another exemplary embodiment of the present invention, a fuse circuit of a semiconductor device, includes a transfer unit configured to selectively transfer a corresponding address signal in response to a test mode signal, a fuse control unit configured to drive an output end with a first voltage in response to an output signal of the transfer unit, a fuse unit including a MOS transistor having a gate coupled with the output end; and a fuse enable unit configured to selectively supply a second voltage to a source/drain of the MOS transistor of the fuse unit in response to the test mode signal, wherein the MOS transistor is short-circuited by a voltage difference between the first voltage and the second voltage.

### BRIEF DESCRIPTION OF THE DRAWINGS

FIG. 1 is a block diagram of a fuse circuit of a semiconductor memory device in accordance with an exemplary embodiment of the present invention.

FIG. 2 is a circuit diagram of the fuse circuit shown in FIG. 1 in accordance with a first exemplary embodiment of the present invention.

FIG. 3 is a block diagram illustrating a plurality of fuse circuits in accordance with an exemplary embodiment of the present invention.

FIG. 4 is a circuit diagram of the fuse circuit shown in FIG. 1 in accordance with a second exemplary embodiment of the present invention.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

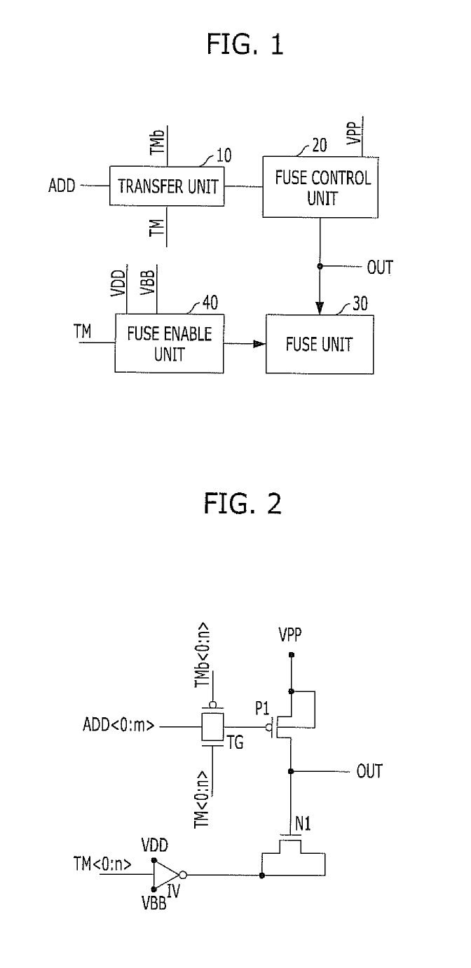

FIG. 1 is a block diagram of a fuse circuit of a semiconductor memory device in accordance with an exemplary embodiment of the present invention.

Referring to FIG. 1, the fuse circuit of the semiconductor memory device in accordance with the exemplary embodiment of the present invention includes a transfer unit 10, a fuse control unit 20, a fuse unit 30, and a fuse enable unit 40. The transfer unit 10 selectively transfers an address signal ADD in response to a test mode signal TM and TMb. The fuse control unit 20 drives an output end OUT with a high voltage VPP in response to an output signal of the transfer unit 10. The fuse unit 30 includes a MOS transistor whose gate is coupled to the output end OUT. The fuse enable unit 40 selectively provides a power supply voltage VDD or a back bias voltage VBB to a source/drain of the MOS transistor included in the fuse unit 30 in response to a test mode signal TM.

FIG. 2 is a circuit diagram of the fuse circuit shown in FIG. 1 in accordance with a first exemplary embodiment of the present invention.

Referring to FIG. 2, the fuse circuit includes a transfer gate TG, a PMOS transistor P1, an inverter IV, and an NMOS transistor N1. The transfer gate TG selectively transfers a corresponding address signal ADD<0:m> in response to a corresponding test mode signal TM<0:n> and TMb<0:n>. The PMOS transistor P1 receives an output signal of the transfer gate TG through a gate and includes a source coupled with a high voltage VPP end and a drain coupled with the output end OUT. The inverter IV selectively outputs a power supply voltage VDD or a back bias voltage VBB in response to the logic level of the corresponding test mode signal TM<0:n>. The NMOS transistor N1 includes a gate coupled with the output end OUT and a source/drain coupled with the output end of the inverter IV.

Hereinafter, one unit fuse circuit is described as an example for illustrating the operation of the fuse circuit illustrated in FIG. 2.

First, a test mode signal TM<n> is in a logic low level in a normal mode. Therefore, the transfer gate TG is turned off and the gate-source voltage Vgs of the PMOS transistor P1 always has a value lower than 0V. Therefore, the PMOS transistor P1 is turned on so as to drive the output end OUT with a high voltage VPP. Also, since the input signal of the inverter IV is in a logic low level, the output signal of the inverter IV comes to be in a logic high level. In short, the source and drain of the NMOS transistor N1 are driven with the power supply voltage VDD. In this case, the NMOS transistor N1 may be turned on but the output end OUT may not be driven to be in a logic low level.

Subsequently, when a test mode is performed to program the fuse circuit after packaging, the level of the test mode signal TM<n> becomes a logic high level. Therefore, the transfer gate TG is turned on to output an address signal ADD<m>, and since the input signal of the inverter IV is in a logic high level, the output signal of the inverter IV is a signal of a logic low level, that is, a signal of a back bias voltage VBB level. In this case, since the gate of the NMOS transistor N1, that is, the output end OUT, is driven with a high voltage VPP and the source/drain is driven with a back bias voltage VBB, a voltage as high as VPP-VBB is applied between the gate of the NMOS transistor N1 and the source/drain. Therefore, the gate insulation layer of the NMOS transistor N1 is broken down to short-circuit the output end OUT and the back bias voltage VBB end and the logic level of the output end OUT transitions to a logic low level.

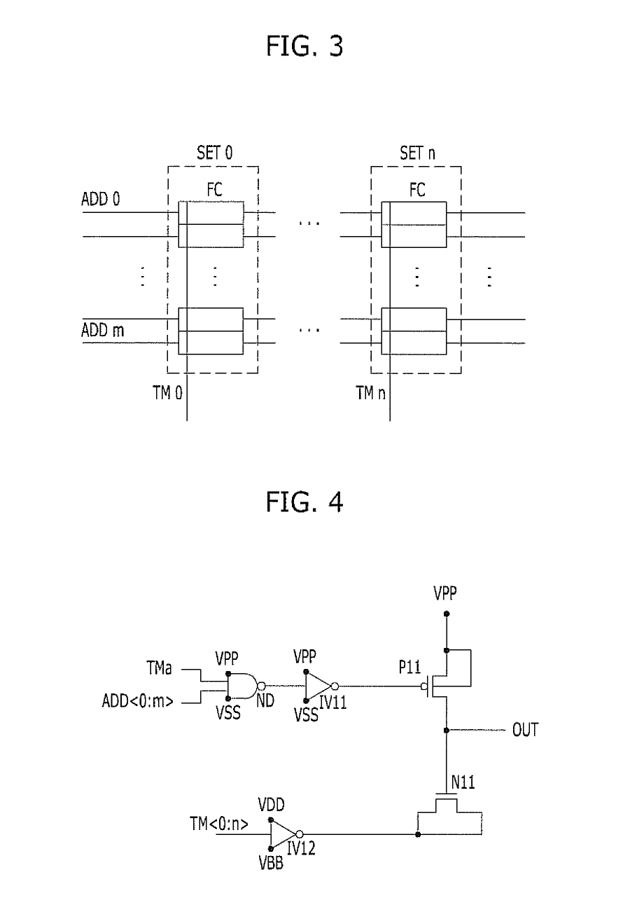

FIG. 3 is a block diagram illustrating a plurality of fuse circuits in accordance with an exemplary embodiment of the present invention.

Referring to FIG. 3, a plurality of fuse circuits FC respectively corresponding to the address signal ADD<0:m> form one fuse set, and there are a plurality of fuse sets SET<0:n>. The fuse sets SET<0:n> may be controlled based on the corresponding test mode signal TM<0:n>.

FIG. 4 is a circuit diagram of the fuse circuit shown in FIG. 1 in accordance with a second exemplary embodiment of the present invention.

Referring to FIG. 4, the fuse circuit includes a NAND gate ND, an inverter IV11, a PMOS transistor P11, an inverter IV12, and an NMOS transistor N11. The NAND gate ND receives another test mode signal TMa and a corresponding address signal ADD<0:m>. The inverter IV11 receives an output signal of the NAND gate ND. The PMOS transistor P11 receives an output signal of the inverter IV11 through a gate and includes a source coupled with a high voltage VPP end and a drain coupled with an output end OUT. The inverter IV12 selectively outputs a power supply voltage VDD or a back bias voltage VBB in response to the logic level of the corresponding test mode signal TM<0:n>. The NMOS transistor N11 includes a gate coupled with the output end OUT and includes a source/drain coupled with the output end of the inverter IV12.

The configuration of the second embodiment is the same as the first embodiment, except that the transfer unit 10 is realized as the NAND gate ND and the inverter IV11. In terms of operation, the second embodiment is the same as the first, except that the corresponding address signal ADD<0:m> is not blocked off but inputted only when the test mode signal TMa is enabled.

Here, the test mode signal TM<0:n> is a test mode signal for fuse programming, and the test mode signal TMa is another test mode signal that is different from the test mode signal TM<0:n>. The address signal ADD<0:m> is transferred while the test mode signal TMa is activated in a logic high level.

According to an exemplary embodiment of the present invention, fuse programming may be carried out in a test mode by using a fuse circuit that is designed based on the breakdown of a gate insulation layer of a MOS transistor occurring due to a voltage level difference. This means that the fuse programming may be performed even after packaging, and the circuit area occupied by the fuse circuit may be reduced, compared with the metal line fuse blowing method using a laser beam. Also, since the fuse programming using a test mode may be performed on the basis of a fuse set, it may be desirable in terms of operation time as well.

While the present invention has been described with respect to the specific embodiments, it will be apparent to those skilled in the art that various changes and modifications may be made without departing from the spirit and scope of the invention as defined in the following claims.

That is, a case that fuse programming is performed in such a manner that the breakdown of a MOS transistor is caused by applying a high voltage VPP and a back bias voltage VBB to both ends of a MOS transistor, which is used as a fuse, is described as an example in the above-described embodiment of the present invention. The high voltage VPP and the back bias voltage VBB, however, are taken because they are the voltages of the greatest voltage difference in a typical semiconductor device. The high voltage VPP and the back bias voltage VBB may be substituted with other voltages that may have voltage difference to cause the breakdown of the MOS transistor, according to embodiments of the present invention.

What is claimed is:

1. A fuse circuit of a semiconductor device, comprising:
a transfer unit configured to selectively transfer a corresponding address signal in response to a test mode signal;
a fuse control unit configured to drive an output end with a first voltage in response to an output signal of the transfer unit;
a fuse unit including a MOS transistor having a gate coupled with the output end; and
a fuse enable unit configured to selectively supply a second voltage to a source/drain of the MOS transistor of the fuse unit in response to the test mode signal,
wherein the fuse circuit is programmed by causing a breakdown of the MOS transistor in response to a voltage difference between the first voltage and the second voltage.

2. The fuse circuit of claim 1, wherein the first voltage is a high voltage VPP.

3. The fuse circuit of claim 2, wherein the second voltage is a back bias voltage VBB.

4. The fuse circuit of claim 1, wherein the transfer unit comprises a transfer gate for selectively transferring the corresponding address signal in response to the test mode signal.

5. The fuse circuit of claim 1, wherein the fuse control unit comprises a PMOS transistor that receives an output signal of the transfer unit through a gate, receives the first voltage through a source, and includes a drain coupled with the output end.

6. The fuse circuit of claim 1, wherein the fuse enable unit comprises an inverter for selectively outputting a power supply voltage and the second voltage in response to the test mode signal.

7. The fuse circuit of claim 1, wherein the fuse unit includes an NMOS transistor that includes a gate coupled with the output end and receives an output signal of the fuse enable unit through a source/drain.

8. A fuse circuit of a semiconductor device, comprising:
a transfer unit configured to selectively transfer a corresponding address signal in response to a first test mode signal;
a fuse control unit configured to drive an output end with a first voltage in response to an output signal of the transfer unit;
a fuse unit including a MOS transistor having a gate coupled with the output end; and
a fuse enable unit configured to selectively supply a second voltage to a source/drain of the MOS transistor of the fuse unit in response to a second test mode signal,
wherein the MOS transistor is broken down by a voltage difference between the first voltage and the second voltage.

9. The fuse circuit of claim 8, wherein the first voltage is a high voltage VPP.

10. The fuse circuit of claim 8, wherein the second voltage is a back bias voltage VBB.

11. The fuse circuit of claim 8, wherein the transfer unit comprises:
a NAND gate configured to receive the first test mode signal and the corresponding address signal; and
an inverter configured to receive an output signal of the NAND gate.

12. The fuse circuit of claim 8, wherein the fuse enable unit comprises an inverter for selectively outputting a power supply voltage and the second voltage in response to the second test mode signal.
